(19) United States
(12) Patent Application Publication
(10) Pub. No.: US 2026/0170295 A1
(43) Pub. Date: Jun. 18, 2026

(54) METHOD AND SYSTEM FOR AUGMENTING GRAPH DATA

(71) Applicant: The University of Hong Kong, Pokfulam (CN)

(72) Inventors: Lequan Yu, Pokfulam (CN); Tsai Hor Chan, Pokfulam (CN); Yushi Feng, Pokfulam (CN)

(21) Appl. No.: 19/401,792

(22) Filed: Nov. 26, 2025

Related U.S. Application Data
(60) Provisional application No. 63/734,314, filed on Dec. 16, 2024.

(51) Int. Cl. G06N 3/042; G06N 3/082

(52) U.S. Cl. CPC G06N 3/042; G06N 3/082

(57) ABSTRACT

A computer-implemented method for augmenting graph data for use in training a graph neural network (GNN) includes: receiving input data, generating original graph data based on the input data, generating one or more knowledge graphs based on context related inputs, augmenting the original graph data by applying the knowledge graphs to generate augmented graph data, and; training a graph neural network (GNN) using the augmented graph data. The GNN is trained to extract relational data in the input data. One or more knowledge graphs are generated by a large language model (LLM) by prompting the LLM with context related text inputs. The method also includes dynamically merging the one or more knowledge graphs with the original graph, wherein the one or more knowledge graphs are stochastically integrated with the original graph.

### TECHNICAL FIELD

The present disclosure relates to a method and system for augmenting graph data, in particular, but not limited to a method and system for augmenting graph data for use in training a graph neural network (GNN).

### BACKGROUND

Graph representation learning has received increasing attention in recent years. It achieves great success in solving tasks where relational features are important, such as recommendation systems, citation networks, and medical records analysis. However, the scarcity and noise present in graph data pose great challenges for effective graph learning, necessitating the development of graph data augmentation algorithms.

Existing graph data augmentation methods focus on graph structures for data augmentation, such as randomly dropping nodes or edges, adding Gaussian noise to the node or edge attributes, or applying graph-based transformations such as sub-sampling and node permutation. While these methods have demonstrated some successes in graph representation learning scenarios they do not consider the context or attributes associated with the graph data.

Some recent research has been conducted that leverage LLM for graph representation learning. Despite their success, they are mostly white-box which require access to the weights or latent features from the LLMs, making them difficult to be democratized as existing LLMs are mostly closed-source for commercial considerations. As a result, the resulting augmented graph becomes less identifiable due to a lack of contextual guidance.

Furthermore, most of these augmentation methods leverage in-domain knowledge under a close-world setting, which does not borrow the vast repositories of knowledge in the open world. Additionally, the sparsity of the augmented graph is not well studied, although some methods, such as DropEdge, attempt to sparsify the graph for augmentation. Without proper sparsity control, the augmented graph would be over-sparsified and likely reduced to trivial graphs (i.e., uninformative graphs).

These limitations illustrate the necessity of developing a new graph data augmenter under open-world settings with proper sparsity control, such that the augmented graph can be closer to the true data distribution.

### SUMMARY

The present disclosure relates to a method and system for augmenting graph data, which in one example may be for use in training a graph neural network (GNN)

According to a first aspect, there is provided a computer-implemented method for augmenting graph data for use in training a graph neural network (GNN), comprising the steps of:
receiving input data,
generating original graph data based on the input data,
generating one or more knowledge graphs based on context related inputs,
augmenting the original graph data by applying the knowledge graphs to generate augmented graph data, and;
training a graph neural network (GNN) using the augmented graph data.

The method is advantageous because it provides an improved graph data for training a GNN. The method is advantageous because the enriched i.e., augmented graph data leads to better performance in graph representation learning tasks and offers enhanced interpretability, particularly beneficial in fields like medical informatics.

In one example, the method wherein the GNN is trained to extract relational data in the input data. The GNN may be used for a number of downstream tasks such as for example Electronic Health Record (EHR) processing.

In one example the one or more knowledge graphs are generated by a large language model (LLM) by prompting the LLM with context related text inputs.

By leveraging LLM-generated knowledge graphs, it incorporates extensive contextual and domain-specific knowledge that existing methods overlook. This is advantageous because the knowledge graphs generated by the LLM are used to augment the graph data with additional context specific information.

In one example, the LLM may be pre trained LLM e.g., a pre trained generative LLM.

In one example, the method comprising the step of dynamically merging the one or more knowledge graphs with the original graph, wherein the one or more knowledge graphs are stochastically integrated with the original graph.

In one example, the method comprising the additional step of performing context driven knowledge retrieval by utilising the input data and the LLM, and wherein the LLM is a frozen.

In one example the one or more knowledge graphs are context specific based on one or more prompts.

In one example, the method comprising the further steps of:
determining a granularity level of the input data or the original graph,
selecting a granularity level,
wherein the granularity level is selected to control a sparsity of the knowledge graphs.

In one example, the method comprising the further steps of:
Identifying or selecting contextual information,
generating contextual prompts,
providing the contextual prompts to the LLM.

The method's dynamic merging strategy and granularity-aware prompting ensures that the augmented graph data maintains a balance between richness of information and manageability while avoiding over sparsification.

In one example, the method comprising the step of refining the one or more generated knowledge graphs by recursively calling the LLM and pruning less relevant nodes and edges in at least one of the one or more generated knowledge graphs.

In one example, the method comprises the further step of instruction fine tuning to control the sparsity of the one or more knowledge graphs, wherein the instruction fine tuning causes the generated knowledge graphs to be pruned such that trivial concepts are removed.

In one example, instruction fine tuning may be applied as part of developing prompts for the pre trained LLM.

According to a second aspect, there is provided a system for augmenting graph data for use in training a graph neural network (GNN) comprising:
a computing apparatus,
the computing apparatus comprising a processor and a computer readable medium,
the computer readable medium comprising instructions which, when executed by the processor, cause the computing apparatus to carry out the method described in any one or more of the statements above.

According to a further aspect, there is provided a data processing apparatus comprising a means for carrying out the method of any one of the statements earlier or herein.

According to a further aspect, there is provided a computer program comprising instructions which, when the program is executed by a computing apparatus, cause the computing apparatus to carry out the method of any one of the statements earlier or herein.

According to a further aspect, there is provided a computer-readable medium comprising instructions which, when executed by a computer (or a computing apparatus), cause the computer (or the computing apparatus) to carry out the method of any one of statements above or herein.

According to a further aspect, there is provided a system for augmenting graph data for use in training a graph neural network (GNN) comprising:
a knowledge graph construction module,
wherein the knowledge graph construction module is configured to generate one or more knowledge graphs,
a graph data augmentation module, wherein the graph data augmentation module being operatively coupled to the knowledge graph construction module,
wherein the graph data augmentation module is configured to generate augmented graph data by dynamically merging the generated one or more knowledge graphs with original data generated from input data, and;
a GNN module that is trained by using the augmented graph data.

In one example, the knowledge construction module, and graph data augmentation module may be implemented as a computer program or may be embodied as computer readable and executable instructions stored in a memory unit.

In one example, the knowledge construction module and the graph data augmentation module may be embodied as a machine learning model e.g., as a neural network that is adapted to be executed by a processing unit (e.g., a GPU or CPU) of a computing apparatus.

According to a further aspect, there is provided a computer-implemented method of training a graph neural network (GNN) using augmented graph data, comprising:
receiving an input training dataset comprising original graph data and one or more knowledge graphs generated by a pre trained LLM,
merging the knowledge graphs and original graph data to generate augmented graph data, and;
training the GNN using the augmented graph data.

According to a further aspect, there is provided a computer-implemented method of generating a training dataset for a graph neural network GNN, comprising:
receiving input data,
generating original graph data by processing the input data,
generating one or more knowledge graphs from a pre trained LLM, by providing context related prompts to the pre trained LLM, wherein the prompts are based on a specified granularity level,
refining the one or more generated knowledge graphs by recursively calling the LLM and pruning less relevant nodes, and;
dynamically merging the one or more knowledge graphs with the original graph data by stochastic integrating of the knowledge graphs with the original graph data to product the training dataset for training the GNN.

In one example the GNN trained with augmented graph data produced by the method and/or system described above or herein may be adapted for any one or more of:
processing electronic health records,
healthcare predictions based on electronic health records or other health records,
protein structure predictions,
genetic sequencing,
disease prediction based on genetic markers,
recommendation systems.

Other applications and uses are also contemplated.

The method and system described herein is advantageous because it democratises LLM usage. More specifically, the method and system allow utilisation of LLMs in a black box manner without requiring access to their internal workings, making advanced LLM capabilities more accessible.

The term “graph” (may be denoted as G) is a collection of vertices V and edges E, typically represented as G=(V, E). Each edge e∈E is an ordered or unordered pair of representing the connection between them. In the context of graph neural vertices networks, each vertex vi is often associated with a feature vector x; in the feature space X. A knowledge graph (KG) is a specialized type of graph denoted as KG=(V, E, R), where R is a set of relation types. A KG can be constructed from a set of triples T={(hᵢ, rᵢ, tᵢ)}^{|T|}ᵢ₌₁ where hᵢ, tᵢ, and rᵢ are the i-th head and tail nodes respectively, and rᵢ is the relation type for the i-th triple.

“Graph Augmentation” (GDA) as described herein refers to augmenting a graph G. Given G=(V, E), GDA aims to derive an augmented graph G^{aug}=(V^{aug}, E^{aug}), where V^{aug} and E^{aug} represent the augmented set of nodes and edges, respectively.

The augmentation process should preserve or enhance the inherent structure and properties of G, while facilitating improved performance of a GNN (denoted as M) on downstream tasks.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in any other country.

### BRIEF DESCRIPTION OF THE DRAWINGS

Examples of a method and system for augmenting graph data will now be described, by way of example, with reference to the accompanying drawings in which:

FIG. 1 is a schematic diagram of an example form of a system for augmenting graph data used in training a graph neural network.

FIG. 2 illustrates a block diagram of the internal components of a computing apparatus that forms the system of FIG. 1.

FIG. 3 illustrates an example form of a context driven knowledge retrieval system that is implemented to generated augmented graph data.

FIG. 4 illustrates a method for augmenting graph data used in training a graph neural network.

FIG. 5 illustrates an example of the prompting design on the EHR context.

FIG. 6 illustrates an example concept prompting procedure via instruction fine-tuning.

FIG. 7 illustrates a table indicating a summary of the generic graph benchmark datasets.

FIG. 8 illustrates a table indicating a summary of the OGBN datasets.

FIG. 9 presents a summary of the types and counts of the entities in the MIMIC-III dataset, and the details of each task

FIG. 10 illustrates a table that presents the node classification results of the disclosed method of graph data augmentation compared to existing graph data augmentation methods.

FIG. 11 illustrates a table that presents the results on the large-scale OGBN-products and OGBN-arxiv datasets against both traditional and LLM-based competitors.

FIG. 12 illustrates a table that presents the results of different tasks on the MIMIC-III dataset.

FIG. 13 illustrates the results of experiments performed with some renowned black-box LLMs.

FIG. 14 illustrates the TSNE plot of the embeddings generated by different methods.

FIG. 15 illustrates a plot visualising the interpretability of the present model.

FIG. 16 illustrates table showing the effect of augmented KGs on downstream task performance was studied, including three scenarios: with KG, without KG, and with a biased (or wrong) KG augmented from another dataset.

FIG. 17 illustrates the contribution of the dynamic merging schema in a summarised form.

FIG. 18 illustrates the results of a study of the level of sparsity is controlled using the number of edges per concept |E^{conn}| used for KG generation.

FIG. 19 illustrates a table showing the results of the influence of different granularity and instruction fine-tuning (IFT) on augmentation performance.

FIG. 20 illustrates a schematic view of the feature distribution in the original graph data and the augmented graph data compared to a true feature representation.

### DETAILED DESCRIPTION OF EXAMPLE EMBODIMENTS

In light of the vast development of large language models (LLMs), the present disclosure relates to a framework to perform contextual graph data augmentation with a generative pretrained LLM. In one example, the proposed framework may be called DemoGraph. The present disclosure relates to a method and system for augmenting graph data for use in training a graph neural network (GNN).

GNNs are gaining significant success in many problem domains They learn node representation by aggregating information from the neighboring nodes on the graph topology. Most of the existing GNN architectures are on homogeneous graphs. There are also GNN architectures operating on heterogeneous graphs to learn its enriched structural information and complex relations. However, due to limited samples, it is difficult to approximate the true data distribution, especially in the graph domain. Hence, an effective graph data augmentation algorithm is needed to boost the performance of GNNs.

Graph data augmentation (GDA) aims to enhance the utility of the input graph data and produce graph samples close to the true data distribution to alleviate the finite sample bias. Most of the existing works focus on perturbating the graph structures or node features/labels to achieve augmentation, such as node dropping, edge perturbation, graph rewriting, graph sampling, graph diffusion or pseudo-labelling. There are also works that adopt a learn-able graph data augmenter and design specific losses for training. However, these methods mainly focus on the graph structures without considering the contextual information or introducing open-world knowledge. An improved method with higher-level graph structure is needed to address these limitations.

Knowledge distillation from massive EHRs has been a popular topic in healthcare informatics. To address the longitudinal features in the EHR data, several early works attempted to learn the EHR features with recurrent neural networks. Since the EHR data represent relational information between entities (e.g., patients make visits), graphical models turn out to be an ideal approach for representing the EHR data. GRAM is a well-known method that learns robust medical code representations by adopting a graph-based attention mechanism. However, a critical gap remains in these methods: they do not fully incorporate the rich contextual information available in EHR data. This oversight can lead to a lack of nuanced understanding of patient data, impacting the accuracy and applicability of the insights derived. Furthermore, there is a notable absence of effective regularization mechanisms for adjusting to the inherent noise in EHR data, which is cluttered with irrelevant or redundant information.

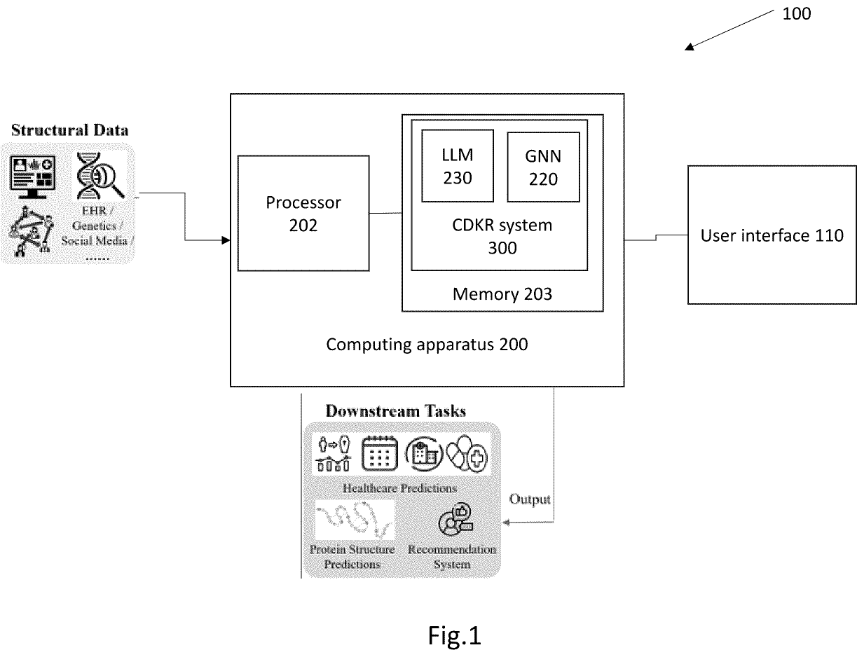

Referring to FIG. 1 an embodiment of a system 100 for augmenting graph data for use in training a graph neural network (GNN). The system 100 comprising: a computing apparatus 200, the computing apparatus 200 comprising a processor 202 (i.e., processing unit) and a computer readable medium (i.e. a memory unit) 203, the computer readable medium comprising instructions which, when executed by the processor, cause the computing apparatus 200 to: receive input data; generate original graph data based on the input data, generate one or more knowledge graphs based on context related inputs, augment the original graph data by applying the knowledge graphs to generate augmented graph data, and train a graph neural network (GNN) using the augmented graph data.

The system 100 may comprise a context driven knowledge retrieval system (CDKR) system 300. The system 300 may be a software system that is executed by the computing apparatus 200 to cause the apparatus to: receive input data; generate original graph data based on the input data, generate one or more knowledge graphs based on context related inputs, augment the original graph data by applying the knowledge graphs to generate augmented graph data, and train a graph neural network (GNN) using the augmented graph data.

The system 100 may comprise a GNN 220 that may be stored in the memory unit and executable by the processor 202. The GNN 220 may be part of the system 100. The GNN may be used in a number of applications. Optionally, the system 100 may comprise a user interface 110 e.g., a display or screen that may be configured to display information to a patient e.g., the status of a method of augmenting graph data, status of training the GNN 220, visual representations of the knowledge graphs or outputs from the GNN processing input data or other outputs. The augmented or improved GNN 220 may be used to provide outputs e.g., perform downstream tasks as shown in FIG. 1.

In one example the GNN is trained to extract relational data in the input data. In one example the one or more knowledge graphs are generated by a large language model (LLM) by prompting the LLM with context related text inputs. The computing apparatus 200 may include an LLM 230 that is stored in a memory unit or database and executable by the processor 202. By leveraging LLM-generated knowledge graphs, it incorporates extensive contextual and domain-specific knowledge that existing methods overlook. This is advantageous because the knowledge graphs generated by the LLM are used to augment the graph data with additional context specific information.

In this example form, the system may be implemented by or as a computing apparatus. The computing apparatus 200 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the method for augmenting graph data.

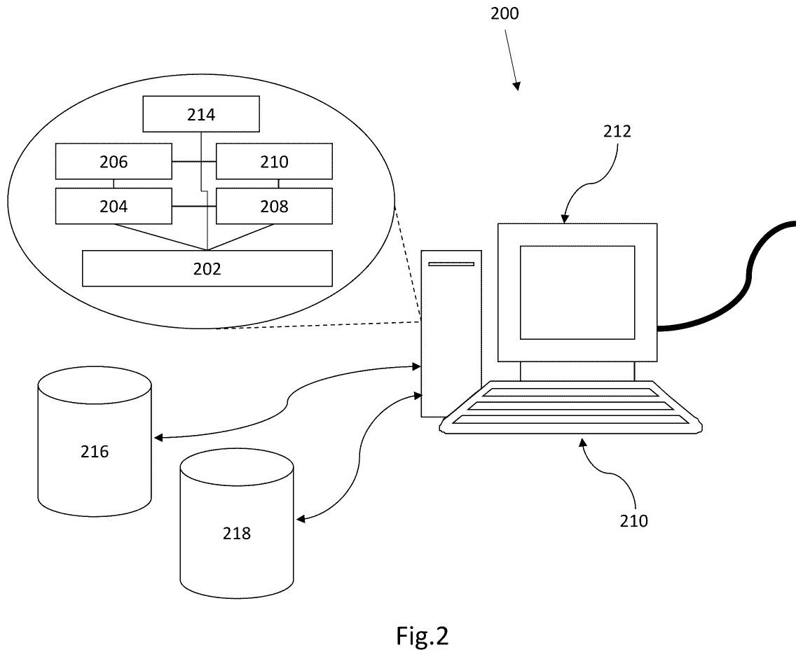

Referring to FIG. 2, there is a shown a schematic diagram of a computing apparatus 200 (i.e., a computer system or computer server or computer) which is arranged to be implemented as an example embodiment of a system for augmenting graph data for training a GNN. In the illustrated example, the computing apparatus 200 which includes suitable components necessary to receive, store and execute appropriate computer instructions. The components may include a processor (i.e., processing unit) 202, including Central Processing Unit (CPU), Math Co-Processing Unit (Math Processor), Graphic Processing Unit (GPUs) or Tensor processing unit (TPUs) for tensor or multi-dimensional array calculations or manipulation operations, read-only memory (ROM) 204, random access memory (RAM) 206, and input/output devices such as disk drives 208, input devices 210 such as an Ethernet port, a USB port, etc.

Optionally, the computing apparatus 200 may include a display 212 such as a liquid crystal display, a light emitting display or any other suitable display. The display 212 may function or operate as a user interface 110 to receive data and communicate data with a user. The display 212 may provide or function as the user interface 110.

The computing apparatus 200 may include instructions that may be included in ROM 204, RAM 206 or disk drives 208 and may be executed by the processing unit 202. There may be provided a plurality of communication links 214 which may variously connect to one or more computing devices such as a server, personal computers, terminals, wireless or handheld computing devices, Internet of Things (IOT) devices, smart devices, edge computing devices. At least one of a plurality of communications link may be connected to an external computing network through a telephone line or other type of communications link.

The computing apparatus 200 may include storage devices such as a disk drive 208 which may encompass solid state drives, hard disk drives, optical drives, magnetic tape drives or remote or cloud-based storage devices. The computing apparatus 200 may use a single disk drive or multiple disk drives, or a remote storage service. The computing apparatus 200 may also have a suitable operating system which resides on the disk drive or in the ROM of the computing apparatus 200.

The computing apparatus may further comprise one or more databases adapted to store one or more pieces of data. For example, input data or knowledge graphs generated in the computing apparatus may be stored in appropriate databases. As shown in FIG. 2, the computing apparatus 200 may include a knowledge graph database 216, and a database of model parameters 218 storing one or more model parameters for the LLM and GNN.

The computing apparatus 200 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing apparatus may comprise one or more GPUs being operatively coupled to the CPU (i.e., processor). The computing apparatus may comprise additional hardware elements operatively coupled to the CPU and/or the GPU to provide the computing apparatus components needed to implement a machine learning network or machine learning model. The learning network or model may be stored in a memory unit e.g., ROM.

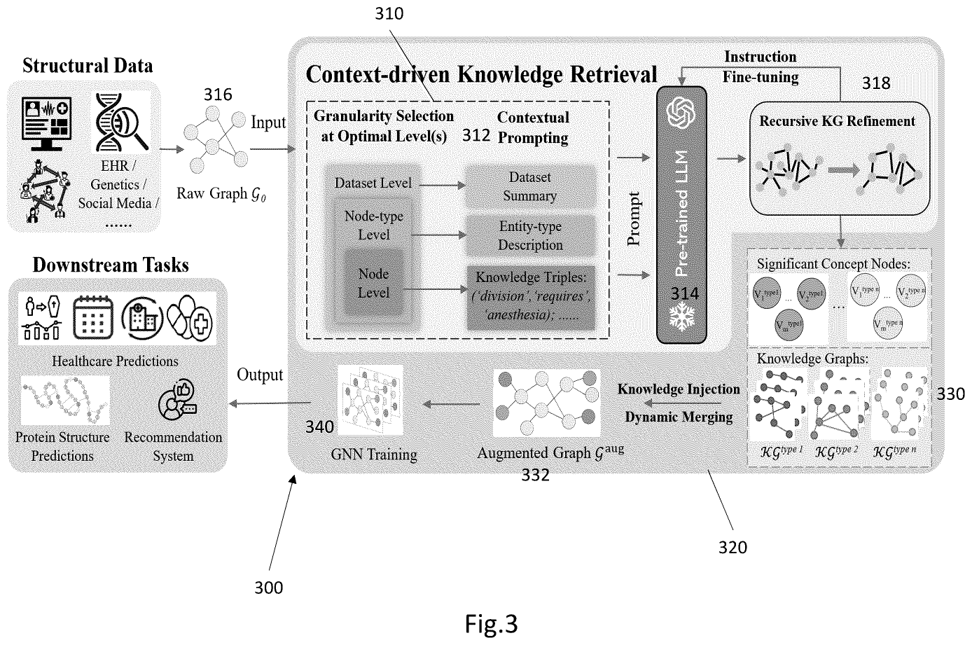

FIG. 3 illustrates a further example detail of the system 100 for augmenting graph data for use in training a graph neural network (GNN). The system 100 is configured to perform context driven knowledge retrieval by utilising a pre trained Large Language Model (LLM) e.g., a frozen generative LLM. FIG. 3 illustrates a diagram of the software system 300 that is used for augmenting graph data. FIG. 3 illustrates one example of a context driven knowledge retrieval system 300 that may be implemented by the computing apparatus 200.

FIG. 3 illustrates a software architecture of the CDKR system 300. The software system 300 may be implemented by the computing apparatus 200. The software system 300 may be used as part of the hardware system 100, shown in FIG. 1.

The system 300 comprises a knowledge graph construction module 310 and a graph data augmentation module 320. The knowledge graph (KG) construction module 310 is adapted to leverage knowledge from one or more LLMs. The graph data augmentation module 320 is configured to inject the knowledge generated in the KG construction module.

Referring to FIG. 3, the KG construction module 310 comprises a prompting engine 312 and a pre trained LLM 314. The prompt engine 312 is configured to apply granularity selection at optimal levels for the dataset level, node type level and node level. Optionally the granularity level may be predefined by an operator. In an alternative form, the granularity level may be automatically selected on one or more parameters e.g., based on the dataset size, the number of nodes required etc. The prompt engine 312 is further configured to create contextual prompts that are fed into the LLM 314. The contextual prompts may include one or more of a dataset summary, entity type description and may be arranged as knowledge triples. The pre trained LLM 314 may be the LLM 230 of FIG. 1.

As shown in FIG. 3, the pre-trained LLM 314 is configured to generate one or more knowledge graphs (KGs) 330 based on the context based and granularity aware prompts provided to the LLM 314. The KGs 330 may be stored in a memory unit or database.

The KG construction module 310 may be further configured to perform recursive KG refinement on the KGs. The KG construction module 310 may be configured to perform instruction fine tuning 318 to control the sparsity of the one or more knowledge graphs, wherein the instruction fine tuning causes the generated knowledge graphs to be pruned such that trivial concepts are removed. The instruction fine tuning may be part of the recursive refinement of the generated KGs.

The graph data augmentation module 320 may be configured to identify significant concept nodes from each of the generated KGs 330. Optionally, the graph data augmentation module 320 may be configured to collate the generated KGs 330. The collated KGs may be stored in a memory unit or database. The graph data augmentation module 320 is configured to dynamically merge the knowledge graphs 330 with the original graph data 316 (i.e., original graph). The KGs 330 may be stochastically integrated with the original graph data, to generate an augmented graph 332 (or augmented graph data). The augmented graph data 332 may be used to train a GNN 340. This improves the performance of the GNN 340 as it is trained using KGs generated from the original input data 302. The enhanced GNN 340 is able to handle downstream tasks across various domains depending on the original input data 302 that is used. The GNN 340 may be the same as the GNN 220 in FIG. 1.

In one example the context driven knowledge retrieval system 300 and its components may be implemented in the computing apparatus 200. The system 300 and its components may be implemented as a computer program or computer readable and executable instructions that may be executed by the computing apparatus.

In an alternative form the system 300 and its components may be implemented as hardware elements or hardware modules e.g., multiple microprocessors. In this alternative form each module may be implemented by a separate microprocessor.

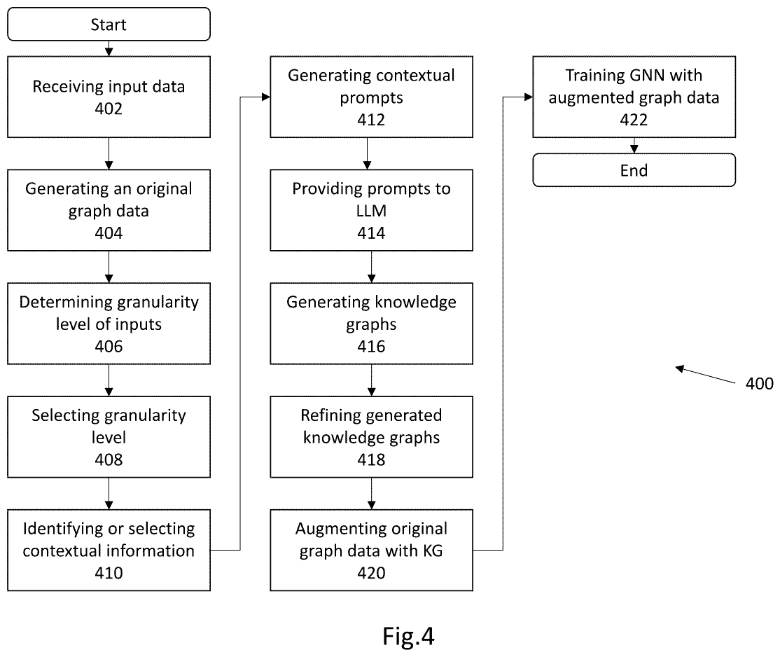

FIG. 4 illustrates an example form of a method 400 for for augmenting graph data for use in training a graph neural network (GNN). The GNN e.g., GNN 340 is adapted to extract or identify relational information in the original data using context driven knowledge retrieval to retrieve additional context. The method 400 commences at step 402. Step 402 comprises receiving input data. The input data may be related to a specific domain. For example, as shown in FIG. 3, the input data 302 may comprise Electronic Health Records (EHR) or generic data or protein data or social media data. The input data 302 may include relational information.

Step 404 comprises generating original graph data based on the input data. The original graph data may be a graph that represents relationships or relation between at least two data types within the input data 302.

The method 400 may comprise the step of performing context driven knowledge retrieval by utilising the input data. In particular, step 406 comprises determining a granularity level of the input data or the original graph. Step 408 comprises selecting a granularity level, wherein the granularity level is selected to control a sparsity of the knowledge graphs. For example, the granularity level may be predefined or set by an operator.

Step 410 comprises identifying or selecting contextual information. The contextual information may be predefined by an operator or may be automatically identified within the original input data or in the original graph data. Step 412 comprises generating contextual prompts. Step 414 comprises providing the contextual prompts to a pre trained LLM e.g., LLM 314. Step 416 comprises generating one or more knowledge graphs KG e.g., KG 330 based on the contextual prompts. In one example the one or more knowledge graphs may be context specific based on one or more prompts.

Step 418 comprises refining the one or more generated knowledge graphs by recursively calling the LLM and pruning less relevant nodes and edges in at least one of the one or more generated knowledge graphs. At step 418 the method may comprise applying instruction fine tuning to control the sparsity of the one or more knowledge graphs, wherein the instruction fine tuning causes the generated knowledge graphs to be pruned such that trivial concepts are removed. In one example, instruction fine tuning may be applied as part of developing prompts for the pre trained LLM.

Step 420 comprises augmenting the original graph data by applying the knowledge graphs to generate augmented graph data. The augmenting process comprises the step of dynamically merging the one or more knowledge graphs with the original graph, wherein the one or more knowledge graphs are stochastically integrated with the original graph. Step 422 comprises training a graph neural network (GNN) using the augmented graph data.

The method 400 is advantageous because it provides an improved graph data for training a GNN. The method is advantageous because the enriched i.e., augmented graph data leads to better performance in graph representation learning tasks and offers enhanced interpretability, particularly beneficial in fields like medical informatics. The method's dynamic merging strategy and granularity-aware prompting ensures that the augmented graph data maintains a balance between richness of information and manageability while avoiding over sparsification.

In one example, the GNN is trained to extract relational data in the input data. The GNN may be used for a number of downstream tasks such as for example Electronic Health Record (EHR) processing.

The method 400 may be executed by the computing apparatus 200. In another example, the method 400 may be executed by the system 100 as described herein. In particular, the method 400 may be executed by the CDKR system 300. The method may be stored in the form of a computer program or as computer readable and executable instructions, that may be executed by a processor e.g., processor 202 of the system 100. The method 400 may be a routine performed by the processor and may follow executable instructions embodied in the CDKR system 300. The method 400 may be repeated multiple times or may be continuously repeated for a predefined number of times or for a predefined period of time.

In one example there may be provided a computer program comprising instructions which, when the program is executed by a computing apparatus e.g., apparatus 200, cause the computing apparatus to carry out the method 400. In another example, there may be provided a computer-readable medium e.g., a memory unit 203 comprising instructions which, when executed by computing apparatus, cause the computing apparatus to carry out the method 400 as described.

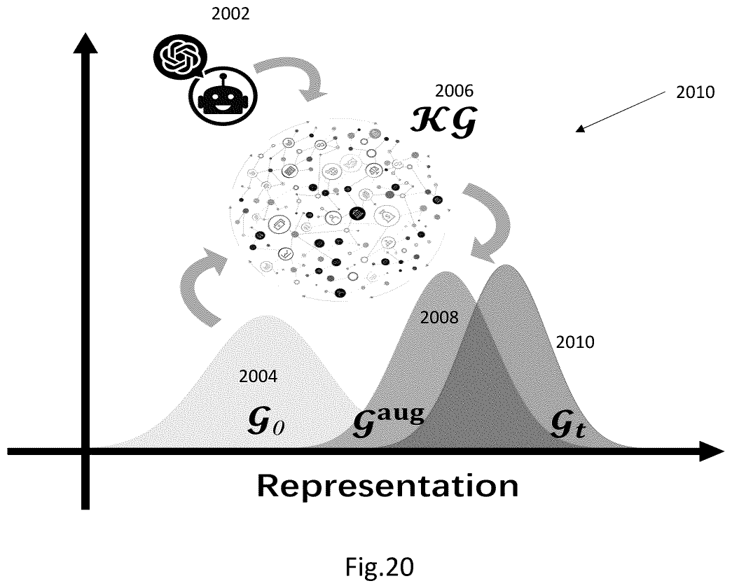

FIG. 20 is a schematic illustration of the application of the method 400 when executed by the system 100. FIG. 20 illustrates the feature distribution of the original graph data G₀ 2004 which generated from processing the input data 2002. G_{aug} 2008 represents the augmented original graph data by the knowledge graphs 2006 generated by the CDKR system 300. The knowledge graphs 2006 may be generated by the methods described herein. Gt 2010 indicates the true graph representation of the input data. As can be seen, the augmented graph data 2008 is closer to the true representation of the relational data in the input data set. This is achieved by generating knowledge graphs KGs from a pre trained LLM that provides contextual information to augment graph data. This provides an improved dataset to train a GNN, resulting in improved outputs from a GNN.

Below is an example overview of the training workflow i.e., a training algorithm 430 for graph data augmentation method.

| | |
|---|---|
| 1. | The input is original graph G₀ = (V₀, E₀) with randomly initialized |
| | node features {xᵢ, ∀i ∈ V}, granularity levels, number of KGs |
| | generated K (per step), ground truth labels y. |
| 2. | The output is Augmented graph G^{aug}, trained GNN model M. |
| 3. | Initialize G^{aug} = G₀ |
| 4. | for each epoch do |
| 5. | V^{KG} ← Get concept nodes as augmentation entities, |
| 6. | {KG}^{K}ᵢ₌₁← Load KGs from V^{KG} |
| 7. | {KG}^{K}ᵢ₌₁ ← Perform instruction fine-tuning with customized |
| | sparsity control on {KG}ᵢ₌₁, |
| 8. | G^{aug} ← merge KG({KG}^{K} , G^{aug}), |
| 9. | Update node indices for all node types in G^{aug} |
| 10. | Get prediction from the GNN y^{\hat{ }} = M(G^{aug}), |
| 11. | Compute training loss L(y^{\hat{ }}, y), |
| 12. | Backpropagate L to M |
| 13. | end for |
| 14. | return Trained GNN M |

The above training algorithm 430 may be executed by the system 100 or the computing apparatus 200.

As described earlier a key advantage of the system and method of augmenting graph data is in the construction or generation of context specific (or context aware) knowledge graphs using LLMs. The context aware KGs (e.g., KG 330) serve as enriched contextual domain knowledge that augments the original graph G₀ towards the true representation Gt. The KG construction is facilitated through a prompting mechanism that steers the LLM toward generating subgraphs focused on specific concepts. The generation process in general can be formulated as T←LLM (prompt), where T={hᵢ, rᵢ, tᵢ)}^{|T|}ᵢ₌₁ represents the set of triples indicating the relationships between generated concepts. A knowledge graph KG can then be constructed from T. The system and method utilize modularized prompts (with placeholders for the descriptions) that are based on all the available information (e.g., the summary of datasets, task descriptions) of the working graph dataset, such that context knowledge can be maximally utilized.

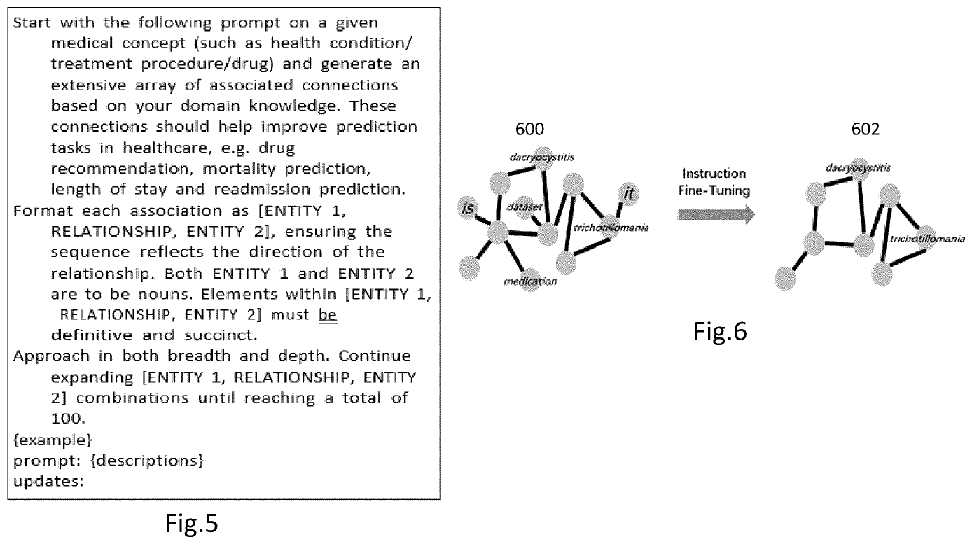

One example of the prompting design on the EHR context is provided in FIG. 5. where the variables as placeholders are inside { }—{example} provides an exemplar triple format, {descriptions} provides the contextual information, and “updates:” prompts the LLM to finish the paragraph. This prompt initially instructs the LLM to identify and generate concept entities V^{KG} and their interrelations E^{KG} driven by the descriptions (e.g., on the dataset or entity) and oriented to the target tasks. Subsequently, the LLM regularizes these relationships into standardized triple formats. Finally, the above prompt expands this structured information both in width and depth, digging into more meaningful and nested relationships, until a pre-defined number of triples is reached.

Example triples are used as prompts to regularise the output formats of T. This multi-step process ensures that the KG is both information rich and aligned with domain specific objectives. Notably, this paradigm utilising placeholders avoids manual prompt customisation, thereby reducing human labour costs.

Naively utilizing the prompting strategy in the previous section would mostly lead to a sparse KG, where data points are unevenly distributed with many gaps or missing links.

Hence, a multi-layer augmentation strategy is used that determines a granularity level prior to generation, such that sparsity of the KG can be controlled.

Granularity refers to the data scale of detail in the augmentation process, ranging from coarse-grained dataset-level to fine-grained node-level information. Based on the availability of information in the working dataset, the variable s is defined as the sparsity level parameter (s increases as the data are more fine-grained), and separate the prompting strategy into three granularity levels, s₀<s₁<s₂, as follows

Dataset-level Augmentation (S=s₀). At the dataset level, the objective is to identify and propagate overarching themes and concepts that are broadly relevant across the dataset. This macro approach involves curating concepts and triples that reflect high-level semantics and dependencies. This is the most fundamental form of the disclosed computer implemented method since dataset-level information is always available.

Type-level Augmentation (s=s₁). Another common scenario is that node type level information (e.g., class labels in texts for classification) is available. The most salient concepts and relationships pertinent to each class or node type may be distilled. By doing so, in-depth understanding of the node categories is gained, fleshing out their characteristics and the interconnections within them. A node-type level prompting example on the Cora dataset (7 classes) is provided later herein.

Node-level Augmentation (s=s₂). In some scenarios (e.g., EHR datasets), the finest information (e.g., text description) on each node (or medical entity) may be gathered or obtained. At this juncture, the aim is to enrich individual nodes with highly relevant and specific concepts that are crucial for the particular tasks. This targeted augmentation ensures that nodes are imbued with unique attributes that can drive predictive tasks more effectively.

Due to the high complexity of given tasks, LLM's one-time retrieval of KGs may contain low-entropy (i.e., uninformative) concepts (e.g., is, dataset, or disease). The method and system are adapted to instruct LLMs to go through a chain-of-thought process to do multi-stage reasoning and self-improve the quality of KGs. FIG. 6 illustrates an example concept prompting procedure via instruction fine-tuning. Given the initial generated KG 600, it is refined by recursively calling the LLM and pruning less relevant nodes and edges, while ensuring that a predefined percentage of the concepts are directly derived from the original dataset. A tuned KG 602 with reduced nodes is outputted following the instruction fine tuning process. The tuned KG 602 includes only the most relevant nodes. The fine-tuning process removes unrelated or uncorrelated nodes.

A template for this instruction fine-tuning (IFT) process is given below (EHR was used as an illustrative example). After this procedure, a set of important concept nodes V^{KG} is then output for triple construction and KG generation.

Given the list of triples augmented with MIMIC-
III dataset. I want to select ‘{number_of_concepts}’
most important triples from the list. The importance
of a triple is based on your knowledge and inference
on how it will help improve prediction tasks in
healthcare, e.g. drug recommendation, mortality
prediction, length of stay, readmission prediction.
If you think a triple is important, please keep it.
Otherwise, please remove it. You can also add triples
from your background knowledge.
triples: {triples}
updates:

Given a constructed KG from T on a sparsity level s, a dynamic merging schema was designed and incorporated to merge KG into G₀. This allows the model to see more augmented samples G^{aug} as a different merged graph is obtained in each optimization step. For each concept node v_{c}∈V^{KG} in KG, a subset of nodes is selected V^{s}={z|z∈V₀}^{nC}⊆V₀, where n_{c}, is the predetermined number of edges per concept node. The concept nodes and the selected nodes were connected from V^{s}₀ to obtain an edge set.

$${E}^{conn} = \{ ( {v}_{c} , z ) \vert ∀ {v}_{c} ∈ {V}^{KG} , z ∈ {{V}^{s}}_{0} \} .$$

After that, the augmented graph G^{aug}=(V^{aug}, E^{aug}) can be obtained by joining the edge sets and node sets, i.e., E^{aug}=E^{conn}∩E₀∩E^{KG} and V^{aug}=V₀#V^{KG}. This dynamic merging is not a one-off operation but an iterative process. Each training epoch sees the refreshment of KGs based on the model's current state, thereby keeping the graph data dynamic and contextually rich. As the model training proceeds, it continually refines the edge weights and node features based on the newly incorporated KGs. This iterative update ensures that the model does not overfit and generalizes well on unseen data. Due to the computation limitations, the number of LLM inferences is limited. Therefore, KG offline may be precomputed and merged with G₀ stochastically during training. Under sufficient computational conditions, the dynamic merging schema allows for online prompting where an up-to-date KG can be generated after every optimization step. On the other hand, the LLM can also be fine-tuned online with task-specific losses. This allows for more context-related KG generations and hence im-proved data augmentation performance. It also enables the potential for training open-world GNN models.

For the training paradigm a GNN is used to predict the labels with the augmented graph as the input, y\hat{ }=M (G^{aug}). Benchmarking was performed with different choices of M: graph convolutional network (GCN), graph attention network (GAT), GraphSAGE, and graph isomorphism network (GIN) (detailed formulations and descriptions of GNNs in appendix). The loss for back-propagation was computed with the predictive labels. For instance, in a multi-class classification task, the cross-entropy loss is adopted, defined as, L_{ce}=−1·N·C y_{i,c} log (softmax(z_{i,c})), where y_{i,c} is the ground truth label for patient i and class c, N is the number of observations, C is the number of classes, and z_{i,c} is logits obtained from the model.

Since EHR contains enriched contextual information that allows for flexible prompting design, the EHR dataset is used to illustrate the disclosed prompting strategy. However, the disclosed prompting strategy is adaptable to other graph datasets, as the placeholders in the modularized prompts can be replaced by information on the target datasets. The KG may be incrementally enlarged such that knowledge from the existing domain can be leveraged to the target domain. A highly adaptive customization strategy may be employed, that tailors the prompt structure based on the specific dataset in use. This strategy includes understanding the data's content and structure and then adjusting the prompts to ensure the generated KGs are optimally suited for the data in question.

A number of experiments using the system 100 utilizing the CDKR system 300 were conducted. The experiments were performed to illustrate the improved performance of the disclosed computer implemented method for augmenting graph data, as executed by the system.

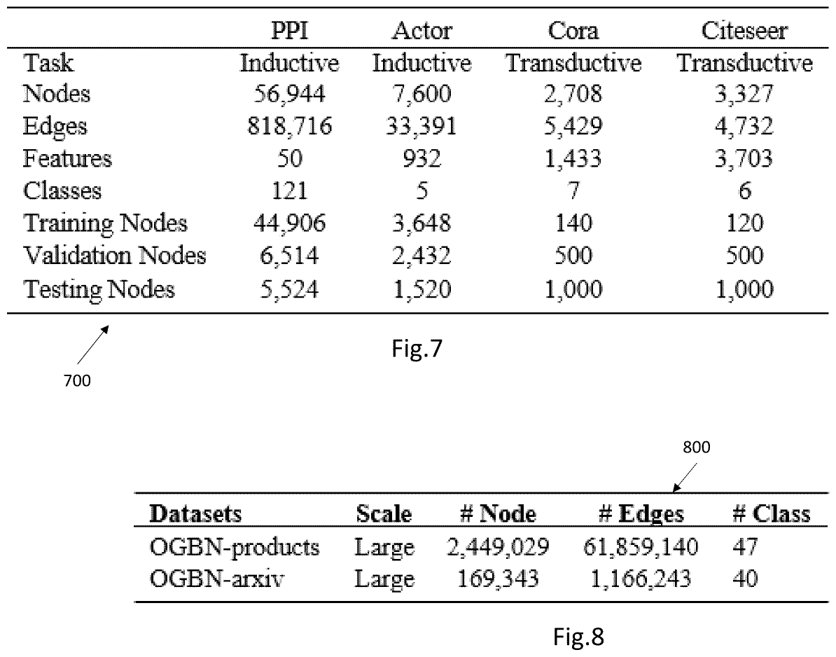

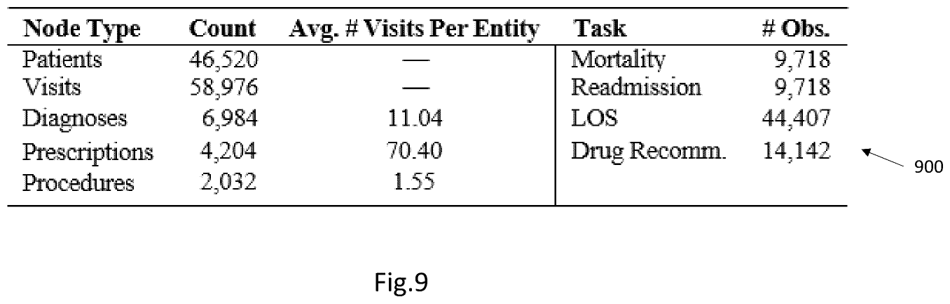

Experiments were performed on generic graph benchmarks (Cora, PPI, Actor, and Cite-seer), where the disclosed computer implemented method was benchmarked on node classification tasks. The scalability of Demo-Graph was validated on two large-scale datasets—OGBN-products and OGBN-arxiv against additional LLM-based methods. FIG. 7 and FIG. 8 provide a summary of these graph datasets from small to large scales. FIG. 7 illustrates a summary of the generic graph benchmark datasets in table 700. FIG. 8 illustrates a summary of the OGBN datasets in table 800. Additionally, an application of the method on a large-scale EHR dataset—MIMIC-III may be executed. It contains a publicly available dataset of 46,520 intensive care unit (ICU) patients over 11 years. Four supervised tasks may be performed—in-hospital mortality prediction (MORT), readmission prediction (READM), length of stay (LOS) prediction, and drug recommendations (DR), where MORT and READM predictions are approached as binary classification tasks, LOS prediction as a multi-class classification task, and DR as a multi-label classification task. Since the lab events are sparse and introduce heavy noise, these are excluded when constructing the graph. The table 900 in FIG. 9 presents a summary of the types and counts of the entities in the MIMIC-III dataset, and the details of each task.

The method of augmenting graph data is evaluated with area under the receiver operating curve (AUROC), area under the precision-recall curve (AUPR), accuracy, F1-scores, and Jaccard index, applied as relevant to each task. For robust validation of the results of the disclosed computer implemented method, a five-fold cross-validation strategy was employed in all major experiments.

During experimentation the disclosed method is compared to the following graph data augmentation methods to validate the empirical performance of DemoGraph: LaplacianPE, Ran-domWalkPE, DropEdge, and DropNode. For the EHR analysis benchmark, tested included adding additional as follows: GraphCare (LLM-based), GRU, Transformer, GRAM, StageNet, Concare, Adacare, Dr. Agent, and GRASP. For drug recommendation, testing also included additional competitors: MICRON, Safedrug, and MoleRec. For the large-scale OGBN datasets, additionally, testing included more advanced LLM-based baselines (i.e., GraphGPT, LLM, TAPE and HiGCN).

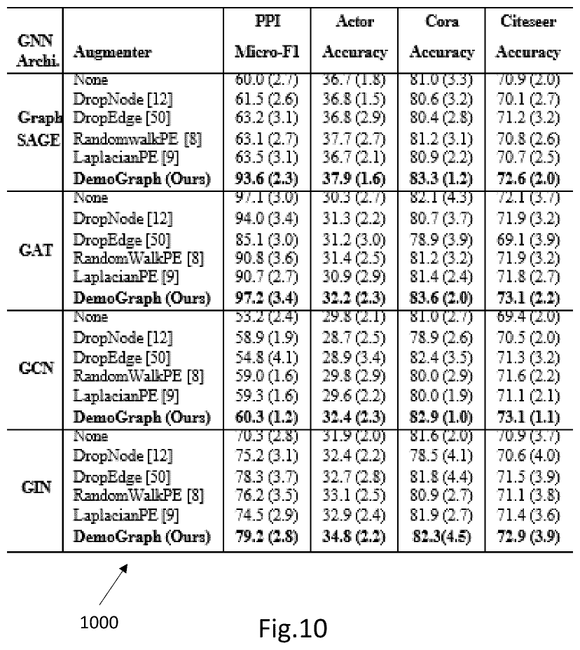

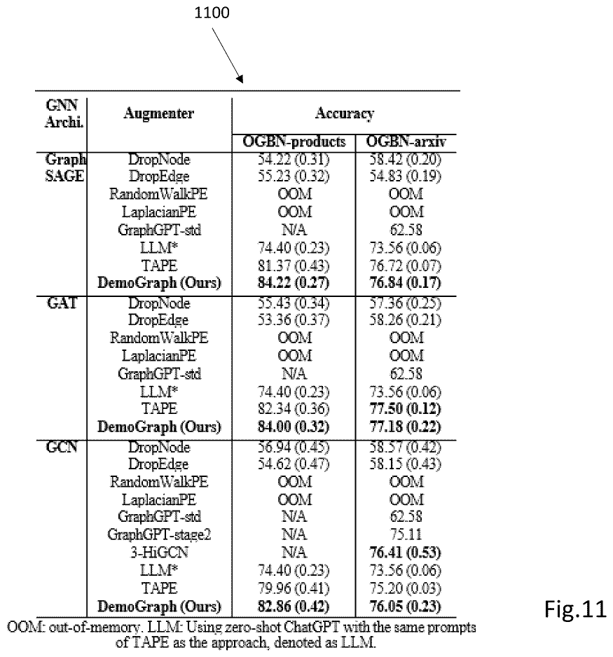

The quantitative results of the system and method as described will now be discussed. Table 1000 shown in FIG. 10 presents the node classification results of using the disclosed graph augmentation method compared to existing graph data augmentation methods. Table 1100 shown in FIG. 11 presents the results on the large-scale OGBN-products and OGBN-arxiv datasets against both traditional and LLM-based competitors. The method as per the present disclosure achieves satisfactory performance on generic graph classification datasets, as well as large-scale datasets. Some of the traditional GDA methods which operate on whole graphs failed to generalize to large-scale datasets (i.e., encountered out-of-memory error). The presently described method obtains a 3% improvement on average over all comparable methods with all four GNN architectures (i.e., GCN, GAT, GIN, and GraphSAGE). This shows evidence that leveraging context knowledge, such as dataset summary and class label information, with LLMs can augment graph data to its true data distribution. The present method performs well among the comparable methods with different GNN architectures. The present method still performs satisfactorily when different GNN architectures are used, demonstrating the robustness of the present method.

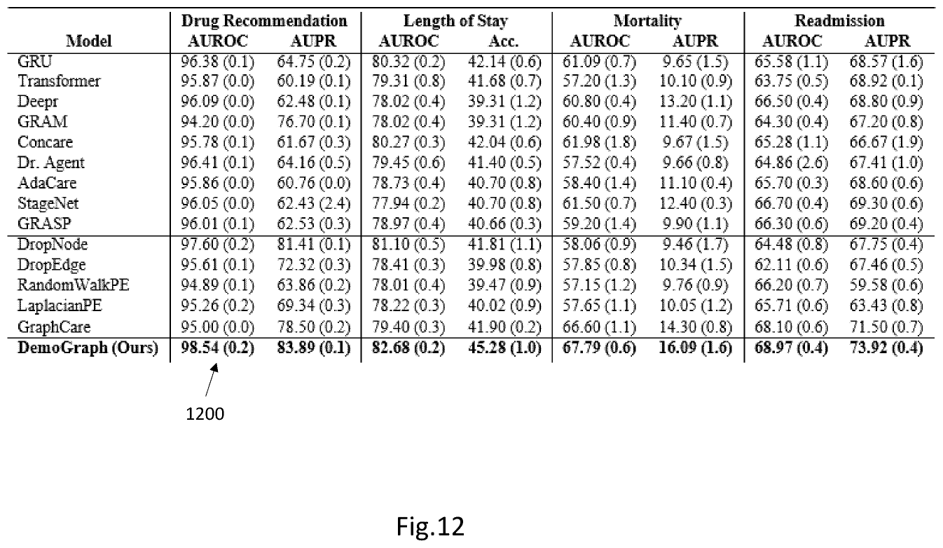

Table 1200 shown in FIG. 12 presents the results of different tasks on the MIMIC-III dataset. The described system and method i.e. the proposed framework outperforms alternative methods, thereby validating the effectiveness of contextual LLM augmentation and sparsity-aware instruction prompting. In particular, the method described herein outperforms the competitors by 7.4% (in accuracy) in length-of-stay prediction. The present method can even outperform the methods specifically designed for EHR analysis, including GraphCare, a similar method using LLM for personalized healthcare.

When integrating the enriched context information (e.g., clinical discharge reports, radiology reports, and lab event reports) in real-world EHR datasets, the performance on clinical task prediction can be further improved.

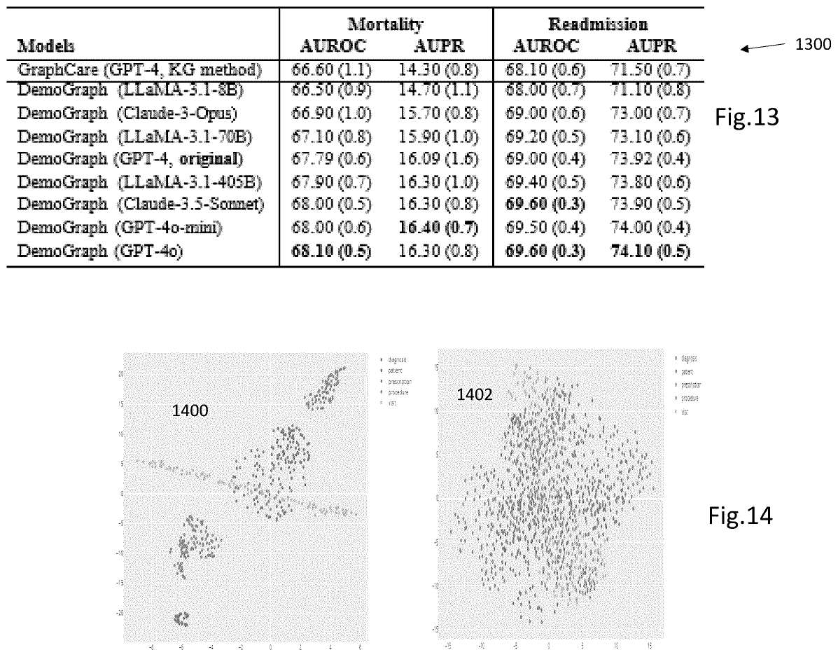

In light of the importance of LLM backbones on the performance of the present method, the effects of LLM backbones with different capacities were studied. Experiments were performed with some renowned black-box LLMs (these LLMs were accessed only through APIs) shown in Table 1300, in FIG. 13. Testing involved observing the differences in model performances, which arise from different training methods and parameter sizes. Nevertheless, the disclosed method can maintain satisfactory performance across different LLM back-bones, validating its robustness. Table 1300 shows a performance of mortality and readmission prediction on MIMIC-III [%] with different LLM backbones. Standard deviations are shown in brackets.

The node embeddings of each type of entity are visualised to evaluate the performance of feature representation learning. FIG. 14 presents the TSNE plot of the embeddings generated by different methods. Plot 1400 illustrates visualisation with graph data augmentation. Plot 1402 illustrates the visualisation without the graph data augmentation. The task is readmission prediction on the MIMIC-III dataset with a GAT model. It is observed that the embeddings with DemoGraph are grouped according to their node types, which validates that the embeddings learn the unique representation of each node type, while the embeddings without Demo-Graph are noisy and do not present a clear pattern by the node type.

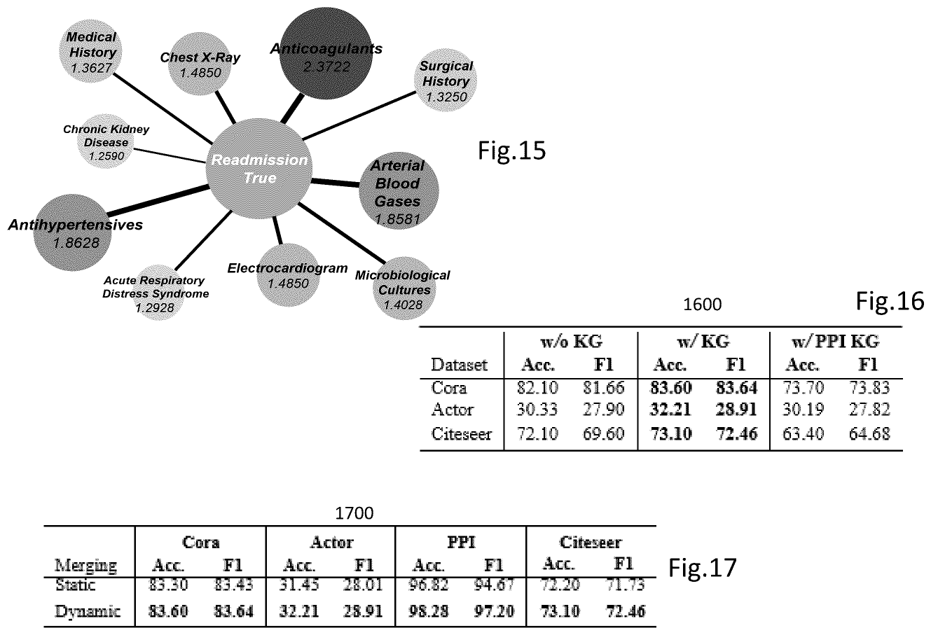

The incorporation of contextual learning enhances the capability of the model by enabling a nuanced understanding and interpretation of the graph data at a deeper level. The interpretability of the present model is analyzed by considering a specific visit node in the MIMIC-III dataset. As shown in FIG. 15, the following are the top augmented corrections (i.e., with the highest attention scores) that exemplify the importance of specific clinical concepts influencing read-mission prediction: Antihypertensives (2.3722), Anti-coagulants (1.8628), and arterial blood gases (1.8581), where the computed attention scores are shown in brackets. It is observed that the augmentation process can impute context-related concepts so that GAT can select the most important ones. This provides interpretations for the predictive process. This is especially beneficial in the clinical decision context since the enriched open-world knowledge can inspire clinicians with the embedded concepts and enhance the understanding of patients' behaviors and the potential reasons for certain diseases.

The effect of augmented KGs on downstream task performance was studied, the results being shown in Table 1600, of FIG. 16 including three scenarios: with KG, without KG, and with a biased (or wrong) KG augmented from another dataset (i.e. PPI). It is observed that the model performs worse than the baseline (i.e., w/o any augmentations) when the wrong context is applied, indicating a biased augmented graph. On the other hand, improved performance is observed when a context-driven KG is applied, thus validating the effectiveness of the disclosed method. A visualization of the effect of DemoGraph on node embeddings can also be found in FIG. 14.

The contribution of the dynamic merging schema is evaluated and summarized in Table 1700, in FIG. 17, where static merging means that the KG are merged into G₀ offline before training. It is observed that the performance improved on all generic graph datasets with dynamic merging, which validates the contributions of the schema.

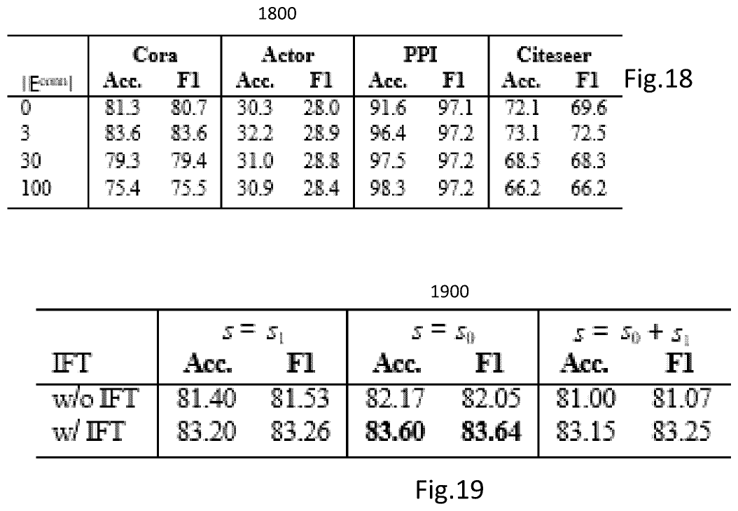

It is demonstrated how different levels of sparsity affect the performance of graph data augmentation. The level of sparsity is controlled using the number of edges per concept |E_{conn}| used for KG generation. Table 1800, shown in FIG. 18 presents the results of this study. Given a fixed number of concepts, the performance im-proves when |E^{conn}| increases, demonstrating the effectiveness of graph merging. However, when |E^{conn}| is too large compared to the original graph size, the augmented graph would be biased from too many noisy connections, and hence the observed performance deteriorates.

The influence of different granularity and instruction fine-tuning (IFT) on augmentation performance was evaluated. From Table 1900, as shown in FIG. 19 it is observed that the performance is improved when an appropriate s is chosen, while adopting a multi-granularity (s₀+s₁) could potentially lead to over-sparsification. With KG concepts pruned by IFT, the performance is consistently improved on different granularity levels.

The system and method provide a new framework e.g., DemoGraph, which leverages the open-world knowledge in LLMs to perform context-driven graph data augmentation. The present method as described directly operates on knowledge graphs constructed from LLM outputs and does not require access to model weights and features, which enables democratization to most of the closed-access LLMs. To tackle the sparsity induced by generated knowledge graphs, a granularity-aware prompting strategy was designed to control the sparsity while maximizing the utility of domain knowledge. Experiments on generic graph datasets and a medical records dataset with an array of GNN architectures validate that the disclosed method can better augment the graph data than existing methods. Ablation analysis on key components and hyperparameters of the present method validates the significance of the disclosed method and robustness to variations. The method as described herein also has a wide range of potential application fields beyond medical record analysis such as molecular chemistry, recommendation, computational biology, social networks, and citation networks etc.

The advantages of the presently described system and method are described below. (1) a black-box method is introduced which leverages extensive knowledge from LLM to perform graph data augmentation without access to model weights or source codes. This is particularly realistic when most LLMs are provided in close-source commercial APIs, enabling the democratization of LLM-based methods. Latent KGs are adopted to capture the structural interactions from the text outputs, as well as a compatible data structure for graph data. (2) A dynamic merging strategy was utilised to stochastically integrate the LLM-generated KGs into the raw graph data during the network training, which guides the optimization trajectory with contextual knowledge. (3) To tackle the sparsity induced by generated KGs, a granularity-aware prompting strategy is applied to control the sparsity while maximizing the utility of domain knowledge. Also, a sequential prompting with instruction fine-tuning strategy to incentivize the LLM to generate the most relevant concepts to the context, and hence high-quality KGs. (4) Extensive experiments on various graph learning tasks validate the effectiveness of the disclosed method over existing graph data augmentation methods. (5) The presently described method demonstrates high scalability across datasets ranging from small to large-scale, consistently delivering satisfactory performance. Notably, the described approach excels in scenarios involving electronic health records (EHRs), where the present method maximizes the utilization of contextual information and leads to enhanced predictive performance and interpretability.

The system and method described herein further provide the following advantages. The system and method democratise LLM usage. In particular, the system and method described herein allows for utilisation of large language models (LLMs) in a black box manner without requiring access to their internal workings, making advanced LLM capabilities accessible to a broader audience. The system and method provide enhanced contextual integration. More specifically, by leveraging LLM generated knowledge graphs, the system and method incorporate extensive contextual, and domain specific knowledge that existing methods often overlook providing improved augmented graph data that can be used to provide improved training for GNNs. The method and system described herein provide a dynamic merging strategy and granularity aware prompting which ensures that the augmented graph maintains optimal balance between richness of information and manageability, while avoiding over sparsification. Finally, the enriched graph data leads to better performance in graph representation learning tasks and offers enhanced interpretability, which is particularly beneficial in fields like medical informatics.

The system and method described herein provide an improved graph data that can be used for better performance in the fields like electronic health record processing, protein structure predictions and other applications.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems described herein are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the described examples as shown in the specific embodiments without departing from the spirit or scope of the system and method for augmenting graph data as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

One or more of the components and functions illustrated the figures may be rearranged and/or combined into a single component or embodied in several components without departing from the scope of the disclosure. Additional elements or components may also be added without departing from the scope of the disclosure. Additionally, the features described herein may be implemented in software, hardware, and/or combination thereof.

In its various aspects, embodiments of the system and/or method for augmenting graph data can be embodied in a computer-implemented process, a machine (such as an electronic device, or a general purpose computer or other device that provides a platform on which computer programs can be executed), processes performed by these machines, or an article of manufacture.

1. A computer-implemented method for augmenting graph data for use in training a graph neural network (GNN), comprising the steps of:
receiving input data,
generating original graph data based on the input data,
generating one or more knowledge graphs based on context related inputs,
augmenting the original graph data by applying the knowledge graphs to generate augmented graph data, and;
training a graph neural network (GNN) using the augmented graph data.

2. The method of claim 1, wherein the GNN is trained to extract relational data in the input data.

3. The method of claim 2, wherein the one or more knowledge graphs are generated by a large language model (LLM) by prompting the LLM with context related text inputs.

4. The method of claim 1, comprising the step of dynamically merging the one or more knowledge graphs with the original graph data, wherein the one or more knowledge graphs are stochastically integrated with the original graph data.

5. The method of claim 1, comprising the additional step of performing context driven knowledge retrieval by utilising the input data and the LLM, and wherein the LLM is a frozen.

6. The method of claim 5, wherein the one or more knowledge graphs are context specific based on one or more prompts.

7. The method of claim 6, comprising the further steps of:
determining a granularity level of the input data or the original graph,
selecting a granularity level,
wherein the granularity level is selected to control a sparsity of the knowledge graphs.

8. The method of claim 6, comprising the further steps of:
Identifying or selecting contextual information,
generating contextual prompts,
providing the contextual prompts to the LLM.

9. The method of claim 7, comprising the step of refining the one or more generated knowledge graphs by recursively calling the LLM and pruning less relevant nodes and edges in at least one of the one or more generated knowledge graphs.

10. The method of claim 9, comprising the further step of instruction fine tuning to control the sparsity of the one or more knowledge graphs, wherein the instruction fine tuning causes the generated knowledge graphs to be pruned such that trivial concepts are removed.

11. The method of claim 10, wherein instruction fine tuning is applied as part of developing prompts for the pre trained LLM.

12. A system for augmenting graph data for use in training a graph neural network (GNN) comprising:
a computing apparatus,
the computing apparatus comprising a processor and a computer readable medium,
the computer readable medium comprising executable instructions which, when executed by the processor, cause the computing apparatus to:
receive input data,
generate original graph data based on the input data,
generate one or more knowledge graphs based on context related inputs,
augment the original graph data by applying the knowledge graphs to generate augmented graph data, and;
train a graph neural network (GNN) using the augmented graph data.

13. The system of claim 12, wherein the GNN is trained to extract relational data in the input data.

14. The system of claim 12, wherein the one or more knowledge graphs are generated by a large language model (LLM) by prompting the LLM with context related text inputs.

15. The system of claim 14, wherein when the executable instructions are executed by the processor, cause the computing apparatus to dynamically merge the one or more knowledge graphs with the original graph data, wherein the one or more knowledge graphs are stochastically integrated with the original graph data.

16. The system of claim 15, wherein when the executable instructions are executed by the processor, cause the computing apparatus to perform context driven knowledge retrieval by utilising the input data and the LLM, and wherein the LLM is a frozen.

17. The system of claim 16, wherein the one or more knowledge graphs are context specific based on one or more prompts.

18. The system of claim 16, wherein the LLM is a pre trained generative LLM.

19. The system of claim 16, wherein when the executable instructions are executed by the processor, cause the computing apparatus to: refine the one or more generated knowledge graphs by recursively calling the LLM and pruning less relevant nodes and edges in at least one of the one or more generated knowledge graphs.

20. The system of claim 19, wherein the computing apparatus is configured to perform instruction fine tuning to control the sparsity of the one or more knowledge graphs, wherein the instruction fine tuning causes the generated knowledge graphs to be pruned such that trivial concepts are removed, and; wherein instruction fine tuning is applied as part of developing prompts for the pre trained LLM.
